(19) United States
(12) Patent Application Publication
(10) Pub. No.: US 2012/0011816 A1
(43) Pub. Date: Jan. 19, 2012

(54) AIR INTAKE STRUCTURE OF AN AIR PURIFIER

(76) Inventor: FU-CHI WU, NORTHRIDGE, CA (US)

(21) Appl. No.: 12/837,994

(22) Filed: Jul. 16, 2010

(51) Int. Cl. B01D 46/44; B01D 46/00

(52) U.S. Cl. 55/418; 55/476

(57) ABSTRACT

An air purifier air intake structure is disclosed to have one or a number of air inlets made on the housing of the air purifier adjacent to the air input port thereof for enabling the air purifier to suck in oxygen rich outdoor air during indoor air circulation and purification operation of the air purifier. By means of the one or a number of air inlets in the air purifier adjacent to its air input port to guide in oxygen rich outdoor air for purification by the air purifier, purified air is discharged into the indoor space through the air output port of the air purifier, increasing (supplying) the oxygen content in the indoor air and enhancing the indoor space purification effect of the air purifier.

### BACKGROUND OF THE INVENTION

1. Field of the Invention

The present invention relates to air purifying technology and more particularly, to an air intake structure of an air purifier, which comprises an air input port and an air output port for circulation of indoor air for purification by an internal air filter, and one or a number of air inlets disposed adjacent to said air input port for guiding in oxygen rich outdoor air for purification and circulation through the air input port and the air output port to increase the oxygen content of the indoor air.

2. Description of the Related Art

In a regular indoor air purifier, the internal fan is operated to suck in indoor air through an air input port thereof for filtration by an internal filter or a number of internal filters for enabling purified air to be sent out of an air output port, keeping the indoor air purified. In order to keep the indoor air clean, the door(s) and window(s) must be closed to keep out outside foul air during operation of an air purifier. Conventional air purifiers are simply designed to filter and purify indoor air. After a certain period of time, the oxygen content in the indoor air will be continuously reduced and carbon oxide content will be continuously increased, affecting human health. If open the door(s) and the window(s) at this time for letting outdoor air in, the high concentration of pollutants in the outdoor foul air will be carried into the indoor space rapidly to mix with the purified indoor air, lowering the air quality of the indoor air and contaminating the indoor purified air.

Because the pollutant particles and fine suspension of the air move in a linear or diffused motion, a minor difference of the concentration of pollutant particles and fine suspension between the indoor space and the outdoor space causes the higher concentration of pollutant particles and fine suspension of the outdoor air to move rapidly into the indoor space to mix with the lower concentration of pollutant particles and fine suspension of the indoor air, lowering the air quality of the indoor space.

This is why a conventional air purifier achieves little improvement in indoor air quality and why dust and fine suspension are still resting on the top of the table after its wire gauze filter has collected a large amount of dust and micro particles during operation.

The outdoor air inlet design of the present invention allows the door and window to be closed to prohibit entering of outdoor micro suspension into the indoor space during the use of the air purifier. During running of the air purifier, outdoor air that contains fresh oxygen is purified by the air purifier and then supplied to the indoor space for breathing by people and animals. Thus, the user of the air purifier can obtain a purified and safe living space, maintaining the physical health of the residents.

### SUMMARY OF THE INVENTION

The main object of the present invention is to provide one or a number of air inlets in the air purifier adjacent to its air input port for enabling the oxygen rich outdoor air to be sucked in by the internal fan of the air purifier during air circulation and purification operation of the air purifier, i.e., when the indoor air is circulating through the air input port and air output port and purified by the air purifier, outdoor air is sucked into the air purifier through the air inlet(s) and purified by the air purifier and then the purified air is discharged out of the air output port into the indoor space. By means of the one or a number of air inlets in the air purifier adjacent to its air input port to guide in oxygen rich outdoor air for purification by the air purifier, purified air is discharged into the indoor space through the air output port of the air purifier, increasing the oxygen content in the indoor air and enhancing the indoor space purification effect of the air purifier.

### BRIEF DESCRIPTION OF THE DRAWINGS

FIG. 1 is a schematic drawing showing an operation status of an air purifier in accordance with a first embodiment of the present invention.

FIG. 2 corresponds to FIG. 1, showing an intake valve installed in the air intake tube.

FIG. 3 is a schematic drawing of the present invention, showing multiple air inlets located on the periphery of the air purifier and multiple air intake tubes respectively connected to the air inlets.

FIG. 4 is a schematic drawing of the present invention, showing an electronic air flow rate control switch installed in the air intake tube adjacent to the air inlet.

### DETAILED DESCRIPTION OF THE PREFERRED EMBODIMENT

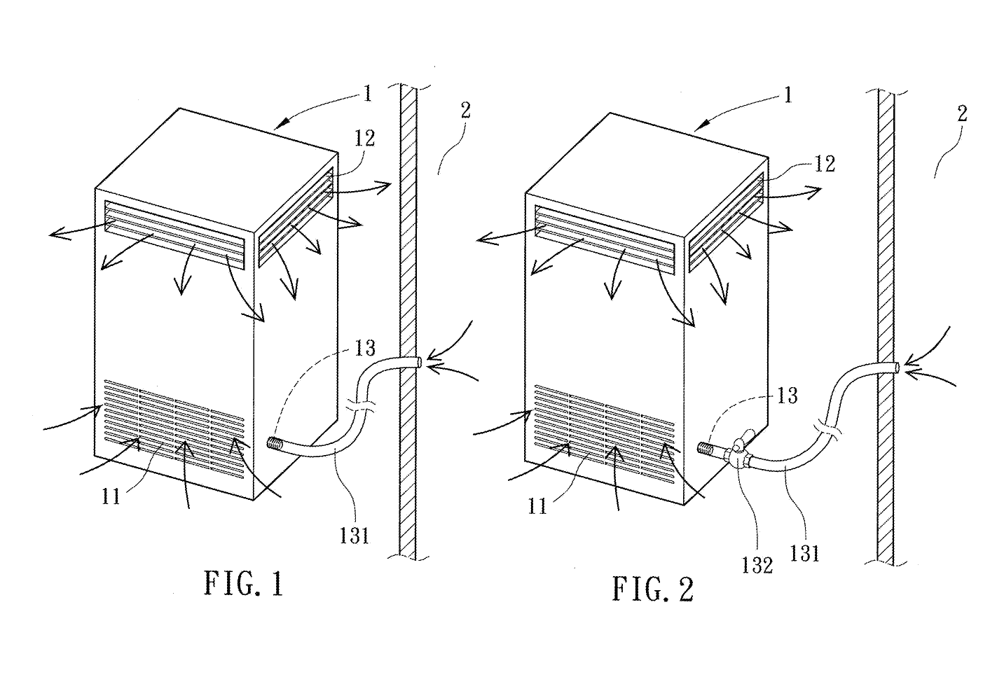

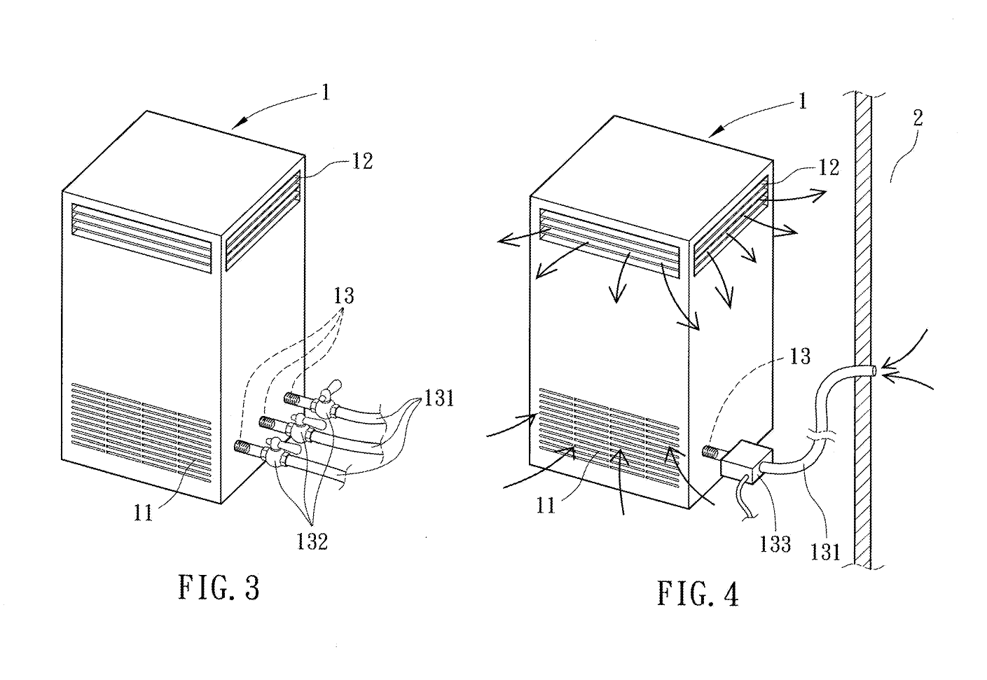

Referring to FIG. 1, an air purifier 1 in accordance with the present invention is shown comprising an air inlet 13 adjacent to the air input port 11 for enabling the oxygen rich air to be sucked into the air purifier 1 from the outdoor space 2 during indoor air circulation and purification operation of the air purifier 1 so that purified air can be discharged through the air output port 12 of the air purifier 1 into the indoor space, increasing the oxygen content in the indoor air. Further, an air intake tube 131 is connected between the air inlet 13 and the outdoor space 2 to guide oxygen rich outdoor air from the outdoor space 2 into the air purifier 1 for purification. Further, a mechanical valve switch 132 is installed in the air inlet 13 or the connected air intake tube 131 for controlling the intake amount of the air from the outdoor space 2, saving indoor energy or controlling the intake amount of outdoor air from the outdoor space 2 (see FIG. 2 and FIG. 3). An electronic air flow rate control switch 133 may be installed in the air inlet 13 or the connected air intake tube 131 and automatically by a control circuit to control the intake amount of outdoor air from the outdoor space 2 automatically (see FIG. 4).

In conclusion, the invention enables the air purifier 1 to suck in outdoor air through the one or a number of air inlets 13 adjacent to the air input port 11 of the air purifier 1 during indoor air circulation and purification operation of the air purifier 1. By means of the one or a number of air inlets 13 in the air purifier 1 adjacent to its air input port 11 to guide in oxygen rich outdoor air for purification by the air purifier 1, purified air is discharged into the indoor space through the air output port 12 of the air purifier 1, increasing the oxygen content in the indoor air and enhancing the indoor space purification effect of the air purifier 1.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An air purifier air intake structure, comprising an air purifier, said air purifier comprising an air input port and air output port formed in a housing thereof, characterized in that:
the housing of said air purifier has an air inlet disposed adjacent to said air input port;
by means of the aforesaid component part, when said air purifier starts an indoor air circulation and purification operation, oxygen rich outdoor air is sucked into said air purifier through the air inlet adjacent to said air input port for real time purification by said air purifier, i.e., when the indoor air is circulating through said air input port and said air output port and purified by the air purifier, outdoor air is sucked into the air purifier through said air inlet and purified by the air purifier, enabling the purified air to be discharged through said air output port to increase the oxygen content in the indoor air.

2. The air purifier air intake structure as claimed in claim 1, wherein an air intake tube is connected between said air inlet and the outdoor space for enabling oxygen rich outdoor air to be sucked into said air purifier for purification.

3. The air purifier air intake structure as claimed in claim 1, wherein a valve switch is installed in said air inlet for controlling the intake amount of outdoor air, saving indoor energy or controlling the intake amount of outdoor air.

4. The air purifier air intake structure as claimed in claim 2, wherein a valve switch is installed in said air inlet for controlling the intake amount of outdoor air, saving indoor energy or controlling the intake amount of outdoor air.

5. The air purifier air intake structure as claimed in claim 1, wherein the housing of said air purifier has at least one air inlet disposed adjacent to said air input port.
